(19) United States
(12) Patent Application Publication
(10) Pub. No.: US 2007/0205672 A1
(43) Pub. Date: Sep. 6, 2007

(54) Linear Motor And Manufacturing Method Of Linear Motor

(76) Inventors: Hajime Nozawa, Tokyo (JP); Takayuki Narita, Tokyo (JP)

Correspondence Address: CANTOR COLBURN, LLP, 55 GRIFFIN ROAD SOUTH, BLOOMFIELD, CT, 06002, US

(21) Appl. No.: 11/629,920

(22) PCT Filed: Jun. 6, 2005
(86) PCT No.: PCT/JP05/10322

§ 371 Date: Dec. 18, 2006

(30) Foreign Application Priority Data
Jun. 21, 2004 (JP) 2004-182077

(51) Int. Cl. H02K 41/00; H02K 15/00

(52) U.S. Cl. 310/12; 29/596

(57) ABSTRACT

In the linear motor 1, which is provided with a pipe shaped member 11, a stator 10 including the pipe shaped member 11 and a plurality of magnets 12, both being accommodated in the stator 10 in such a manner that the plurality of magnets 12 are aligned in a line in the pipe shaped member 11 and same magnetic poles of magnets, being adjacent to each other and included in the plurality of magnets 12, oppose to each other, and a moving part 20 movably disposed on a circumferential surface of the pipe shaped member 11 in an opposing state, the pipe shaped member 11 is provided with a stopper structure 30 disposed at an end portion of the pipe shaped member 11 so as to prevent the plurality of magnets 12 from dropping out of the pipe shaped member 11. Accordingly, it is possible to simply and securely fasten the plurality of magnets 12 into stator 10 without occurring dropouts of the plurality of magnets 12 from the pipe shaped member 11, and without generating any backlash between them.

### FIELD OF THE INVENTION

The present invention relates to a linear motor, and specifically relates to a linear motor that is constituted by a stator in which a plurality of magnets are aligned in a line and a moving part disposed opposite to a circumferential surface of the stator in a movable manner, and a manufacturing method of the linear motor.

### TECHNICAL BACKGROUND

For instance, it has been proposed that the linear motor could be employed for a moving section for which high accurate linear moving action is required, such as a printing head or an exposure scanning head in the field of the office automation apparatus, an exposure scanning devices in the field of the medical apparatus, etc.

Among other things, the shaft type linear motor, typically set forth in Tokkaihei 10-313566 (Japanese Non-Examined Patent Publication), is suitable for a high accurate conveyance purpose in the field of the office automation apparatus from velocity efficiency and a space reduction points of view, compared to the conventional linear motors in which plate type magnets are employed. As shown in FIG. 18, the cylindrical magnets 100, each of which has a through hole at its center, are aligned in the pipe 102 in such a manner that the cylindrical magnets 100 are closely attached to each other by employing the center axes 101. The moving part 120 is movably disposed around the stator 110 created in the abovementioned manner. Generally speaking, however, this kind of structure of the linear motor is expensive due to necessity of the through holes created in the cylindrical magnets 100, and an employment of the center axes 101 increases a number of parts, resulting in disadvantage for the cost reduction.

[Patent Document 1]

Tokkaihei 10-313566 (Page 1-Page 5, FIG. 1-FIG. 5, Japanese Non-Examined Patent Publication)

### DISCLOSURE OF THE INVENTION

Subject to be Solved by the Invention

Since the conventional linear motor employs cylindrical magnets, the conventional linear motor has been expensive. Concretely speaking, since the through hole should be drilled for each of the magnets, its manufacturing cost becomes expensive. In addition to the above, in order to arrange the plurality of magnets in such a direction that the magnets are repelling relative to each other, the center shaft has been employed, resulting in an increase of a number of necessary parts and an increase of manufacturing cost.

The present invention is achieved in view of the problems mentioned in the foregoing. It is an object of the present invention to provide a linear motor and a method for manufacturing a linear motor, which has a cheap structure by reducing a number of parts employed, and which makes it possible to simply and securely mount the plurality of magnets without occurring dropouts of the plurality of magnets from the pipe shaped member, and without generating any backlash between them.

Means for Solving the Subject

In order to solve the problems mentioned in the foregoing, the abovementioned object of the present invention can be attained by the linear motors and the method for manufacturing the linear motor, described as follow.
(1) A linear motor, characterized in that, in the linear motor, which is provided with a pipe shaped member, a stator including the pipe shaped member and a plurality of magnets, both being accommodated in the stator in such a manner that the plurality of magnets are aligned in a line in the pipe shaped member and same magnetic poles of magnets, being adjacent to each other and included in the plurality of magnets, oppose to each other, and a moving part movably disposed on a circumferential surface of the pipe shaped member in an opposing state, the pipe shaped member is provided with a stopper structure disposed at an end portion of the pipe shaped member so as to prevent the plurality of magnets from dropping out of the pipe shaped member.
(2) The linear motor, recited in item 1, characterized in that the stopper structure closely seals the end portion of the pipe shaped member, or an inner diameter of the end portion is smaller than an outer diameter of the plurality of magnets.
(3) The linear motor, recited in item 1, characterized in that the stopper structure is a block member attached to the end portion of the pipe shaped member.
(4) The linear motor, recited in item 3, characterized in that an outer diameter of the block member is substantially equal to an inner diameter of the end portion of the pipe shaped member, and the block member is jointed and fixed onto the end portion of the pipe shaped member.
(5) The linear motor, recited in item 3, characterized in that an outer diameter of the block member is smaller than an inner diameter of the end portion of the pipe shaped member, and the block member is fitted and fixed into the end portion of the pipe shaped member.
(6) The linear motor, recited in item 4, characterized in that the block member has a butting portion fitted and fixed into the end portion of the pipe shaped member so as to butt against the plurality of magnets.
(7) The linear motor, recited in item 4, characterized in that the joining and fixing methods include a welding process, an adhering process, a press-fitting process and a fastening process.
(8) The linear motor, recited in any one of items 3-6, characterized in that the block member is shaped in either a solid column or a cylindrical pipe.
(9) The linear motor, recited in any one of items 1-8, characterized in that a holding member for holding the plurality of magnets is disposed at another end portion located opposite to the end portion at which the stopper structure of the pipe shaped member is disposed.
(10) The linear motor, recited in item 9, characterized in that an attached block member having a female screw section is disposed at the other end portion located opposite to the end portion of the pipe shaped member, and the holding member is screwed and fixed into the attached block member.
(11) The linear motor, recited in item 9 or item 10, characterized in that the holding member is provided with a protruded section for pushing the plurality of magnets so as to hold the plurality of magnets.
(12) The linear motor, recited in any one of items 1-11, characterized in that each of the plurality of magnets is shaped in a column.
(13) The linear motor, recited in any one of items 1-12, characterized in that a soft magnetic material is disposed between any two of the plurality of magnets being adjacent to each other.
(14) The linear motor, recited in any one of items 1-13, characterized in that each of the plurality of magnets is made of a rare metal magnetic material.
(15) The linear motor, recited in item 14, characterized in that each of the plurality of magnets is made of a neodymium material in a category of the rare metal magnetic material.
(16) A method for manufacturing a linear motor, characterized in that a plurality of magnets are inserted into a pipe shaped member having a stopper structure for preventing the plurality of magnets from dropping out of the pipe shaped member from an end portion of the pipe shaped member in such a manner that the plurality of magnets are aligned in a line in the pipe shaped member and same magnetic poles of magnets, being adjacent to each other and included in the plurality of magnets, oppose to each other so as to form a stator, and a holding member is disposed at another end of the pipe shaped member, and a moving part is movably disposed on a circumferential surface of the pipe shaped member in an opposing state.
   Effect of the Present Invention

According to the present invention, the following effects can be attained.

According to the invention described in item 1, since the linear motor is provided with the stopper structure, located at an end portion of the pipe shaped member, for preventing the magnets from dropping out of the pipe shaped member, it becomes possible to insert the plurality of magnets into the pipe shaped member from another end portion of the pipe shaped member so as to assemble and hold them. According to the abovementioned assembly method, it becomes possible to eliminate the conventional center axis, resulting in a reduction of a number of parts required and a cost reduction of the assembly. Further, it also becomes possible to simply and securely mount the plurality of magnets without occurring dropouts of the plurality of magnets from the pipe shaped member, and without generating any backlash between them.

According to the invention described in item 2, since the stopper structure closely seals the end portion of the pipe shaped member, or an inner diameter of the end portion is smaller than an outer diameter of the plurality of magnets, the stopper structure can be easily equipped by processing the pipe shaped member.

According to the invention described in item 3, by attaching the block member to the end portion of the pipe shaped member, the stopper structure formed by a separate member can be easily equipped without processing the pipe shaped member.

According to the invention described in item 4, since the outer diameter of the block member is substantially equal to the inner diameter of the end portion of the pipe shaped member, and the block member is jointed and fixed onto the end portion of the pipe shaped member, the block member never be an obstacle to the movement of the moving member, when the moving member is movably mounted on the outer circumferential surface of the pipe shaped member.

According to the invention described in item 5, since the outer diameter of the block member is smaller than the inner diameter of the end portion of the pipe shaped member, and the block member is fitted and fixed into the end portion of the pipe shaped member, the block member never be an obstacle to the movement of the moving member, when the moving member is movably mounted on the outer circumferential surface of the pipe shaped member.

According to the invention described in item 6, the block member has the butting portion, and the plurality of magnets are held by butting the butting portion against the plurality of magnets.

According to the invention described in item 7, since the joining and fixing methods include a welding process, an adhering process, a press-fitting process and a fastening process, it becomes possible to easily and firmly join and fix the block member onto the end portion of the pipe shaped member.

According to the invention described in item 8, since the block member is shaped in either a solid column or a cylindrical pipe, it becomes possible to easily mount the block member, made of a cheap material, onto the pipe shaped member.

According to the invention described in item 9, since the holding member for holding the plurality of magnets is disposed at the other end portion located opposite to the end portion at which the stopper structure of the pipe shaped member is disposed, it becomes possible to simply and securely mount the plurality of magnets in the pipe shaped member without occurring dropouts of the plurality of magnets from the pipe shaped member, and without generating any backlash between them.

According to the invention described in item 10, since the attached block member is disposed at the other end portion located opposite to the end portion of the pipe shaped member, and the holding member is screwed into the female screw section of the attached block member, it becomes possible to simply and securely mount the plurality of magnets in the pipe shaped member without generating any backlash between them.

According to the invention described in item 11, since the protruded section of the holding member press-pushes the plurality of magnets so as to hold the plurality of magnets, it becomes possible to simply and securely mount the plurality of magnets in the pipe shaped member without generating any backlash between them.

According to the invention described in item 12, since each of the plurality of magnets is shaped in a column and the conventional center through hole should not be drilled for each of the magnets, it becomes possible to reduce the manufacturing cost of the plurality of magnets.

According to the invention described in item 13, it is more preferable that, since the soft magnetic material is disposed between any two of the plurality of magnets being adjacent to each other, the magnetic repulsing force generated between adjacent magnets can be suppressed and the leakage magnetic flux, diverging around the peripheral space, can be increased, resulting in an increase of the thrust force.

According to the invention described in item 14, since each of the plurality of magnets is made of a rare metal magnetic material, it becomes possible to generate a higher thrust force, compared to other kinds of magnets.

According to the invention described in item 15, since each of the plurality of magnets is made of a neodymium material, it becomes possible to generate a still higher thrust force, compared to other kinds of magnets.

According to the invention described in item 16, the plurality of magnets are inserted into the pipe shaped member, having the stopper structure for preventing the plurality of magnets from dropping out of the pipe shaped member from an end portion of the pipe shaped member, in such a manner that the plurality of magnets are aligned in a line in the pipe shaped member and same magnetic poles of magnets, being adjacent to each other and included in the plurality of magnets, oppose to each other so as to form a stator, and a holding member is disposed at another end of the pipe shaped member to hold the plurality of magnets. According to this method for assembling the plurality of magnets, it becomes possible to eliminate the center axis, resulting in a reduction of a number of parts required and a cost reduction of the assembly. Further, it also becomes possible to simply and securely mount the plurality of magnets into stator without occurring dropouts of the plurality of magnets from the pipe shaped member, and without generating any backlash between them.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1(a) and FIG. 1(b) show perspective views of a linear motor embodied in the present invention;

FIG. 2 shows a cross sectional view of a main part of an end portion of the linear motor embodied in the present invention;

FIG. 3 shows a cross sectional view of a main part of another end portion of the linear motor;

FIG. 4 shows a cross sectional view of a main part of another stopper structure embodied in the present invention;

FIG. 5 shows a cross sectional view of a main part of another stopper structure embodied in the present invention;

FIG. 6 shows a cross sectional view of a main part of another stopper structure embodied in the present invention;

FIG. 7(a) and FIG. 7(b) show cross sectional views of a main part of another stopper structure embodied in the present invention;

FIG. 8 shows a cross sectional view of a main part of another stopper structure embodied in the present invention;

FIG. 9(a) and FIG. 9(b) show cross sectional views of a main part of another stopper structure embodied in the present invention;

FIG. 10(a) and FIG. 10(b) show cross sectional views of main parts of other stopper structures embodied in the present invention;

FIG. 11 shows a cross sectional view of a main section of the second end portion of the linear motor;

FIG. 12 shows a cross sectional view of a main section of an example, embodied in the present invention, in which a soft magnetic material is disposed between magnets being adjacent to each other;

FIG. 13 shows an example of calculation results of magnetic flux densities;

FIG. 14 shows a simulation of a thrust force when varying a length of a magnet;

FIG. 15 shows a simulation of a thrust force when varying an inner diameter of a magnet;

FIG. 16 shows a simulation of a thrust force when varying an outer diameter of a magnet;

FIG. 17 shows an explanatory drawing for explaining an operating point and a permeance coefficient; and

FIG. 17 shows a schematic diagram of a conventional linear motor.

### BEST MODE FOR IMPLEMENTING THE INVENTION

Examples of the linear motor and the manufacturing method of the linear motor, embodied in the present invention, will be detailed in the following. However, the scope of the present invention is not limited to the embodiments described in the following. Further, the example exemplified in the following indicates a best mode for implementing the invention, and the scope of the present invention is not limited to the example.

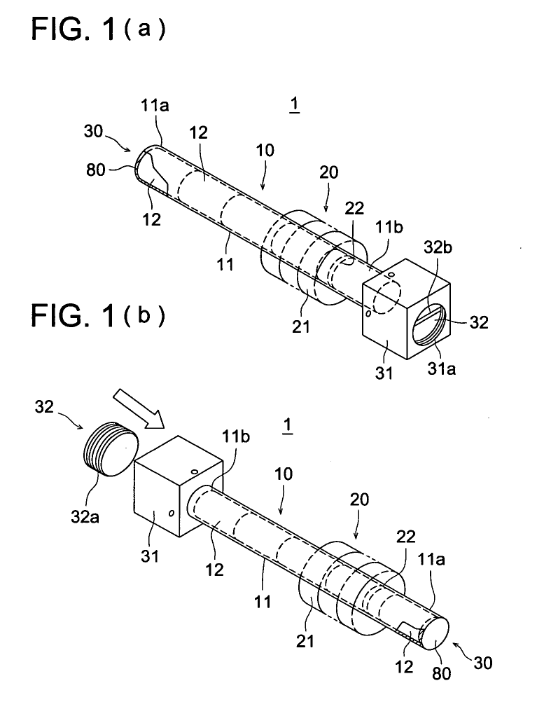

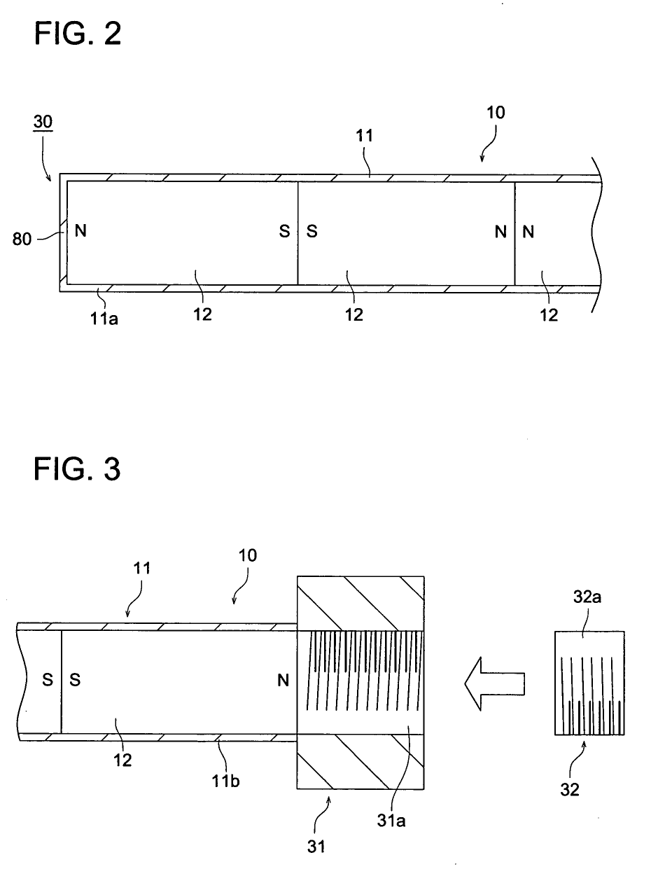

FIG. 1(a) and FIG. 1(b) show perspective views of a linear motor embodied in the present invention, FIG. 2 shows a cross sectional view of an end portion of the linear motor and FIG. 3 shows a cross sectional view of another end portion of the linear motor.

A linear motor 1 embodied in the present invention is constituted by a stator 10 fixed onto a supporting member (not shown in the drawings) and a moving member 20 that linearly moves along a circumferential surface of the stator 10.

The stator 10 includes a pipe shaped member 11 and a plurality of magnets 12 accommodated in the pipe shaped member 11. The plurality of magnets 12 are aligned in a line in the pipe shaped member 11 in such a manner that adjacent magnets closely contact each other without generating any gap.

The moving member 20 includes an electro magnetic coil 21 and a bobbin 22 surrounding an inner circumferential surface of the electro magnetic coil 21. Both the bobbin 22 and the pipe shaped member 11 are supported in such a manner that a gap between the bobbin 22 and the outer circumferential surface of the pipe shaped member 11 is kept at a microscopic distance. The electro magnetic coil 21 could move on the pipe shaped member 11 in either a contacting state or a non-contacting state. Further, it is preferable that a number of windings and a diameter of the winding wire to be employed for the electro magnetic coil 21 are determined at suitable values, so that a generated thrust force is greater than that desired to be obtain and a voltage drop of the linear motor and a voltage drop in the driving circuit are equal to or smaller than the power source voltage.

The pipe shaped member 11 is provided with a stopper structure 30, disposed at a first end portion 11a, and an attached block member 31, disposed at a second end portion 11b, so as to prevent the plurality of magnets 12 from dropping out of the pipe shaped member 11. In this embodiment, the stopper structure 30 includes a cover 80, which is integrally molded on the first end portion 11a of the pipe shaped member 11, so as to closely seal the first end portion 11a. However, it is also applicable that the cover is separately formed as a separate member and fixed onto the first end portion 11a by employing a welding or an adhesive joining so as to closely seal the first end portion 11a.

The attached block member 31 has a female screw section 31a. The plurality of magnets 12 are inserted into the pipe shaped member 11 from the female screw section 31a, so as to accommodate them in the stator 10 in such a manner that the plurality of magnets 12 are aligned in a line in such a direction that same magnetic poles of adjacent magnets oppose to each other. A male screw section 32a of a holding member 32 is screwed into the female screw section 31a of the attached block member 31, in order to fasten it to the attached block member 31. The holding member 32 is provided with a tool engaging groove 32b formed on the top portion of the holding member 32. By engaging a tool (not shown in the drawings) with the tool engaging groove 32b, the holding member 32 is screwed into the female screw section 31a of the attached block member 31 so as to insert and hold the plurality of magnets 12 with pressure into the pipe shaped member 11. Then, the moving member 20 is movably disposed onto the circumferential surface of the pipe shaped member 11 by inserting it from the first end portion 11a.

As mentioned in the above, the plurality of magnets 12 are inserted into the pipe shaped member 11, which has a drop stopping structure at the first end portion 11a, from the second end portion 11b, so as to accommodate them in the stator 10 in such a manner that the plurality of magnets 12 are aligned in a line in such a direction that same magnetic poles of adjacent magnets oppose to each other, while disposing the holding member 32 at the second end portion 11b. According to the aforementioned assembly method for accommodating the plurality of magnets 12 into stator 10, it becomes possible to eliminate the conventional center axis, resulting in a reduction of a number of parts required and a cost reduction of the assembly. Further, it also becomes possible to simply and securely fasten the plurality of magnets 12 into stator 10 without occurring dropouts of the plurality of magnets 12 from the pipe shaped member 11, and without generating any backlash between them.

In addition, since each of the plurality of magnets 12 is shaped in a solid cylinder and it is not necessary to create any conventional through hole at its center, the manufacturing cost of the plurality of magnets 12 can be drastically reduced. It is preferable that the plurality of magnets 12 are made of rare earth metal magnetic materials. Specifically, among the rare earth metal magnetic materials, a neodymium magnetic material, for instance, a neodymium-ferrite-boron magnet (Nd—Fe—B magnet), is preferable, since the neodymium magnetic material makes it possible to obtain a thrust force stronger than that obtained by another magnetic material.

The pipe shaped member 11 could be made of a non-magnetic material, such as an aluminum alloy, a cupper alloy, a non-magnetic stainless steel, etc. Further, it is preferable that the thickness of the pipe shaped member 11 should be as thin as possible, so as not to weaken the magnetic field to be exerted onto the moving member 20 disposed outside the pipe shaped member 11. As an example, a stainless steel plate having a thickness of about 1 mm could be employed for forming the pipe shaped member 11.

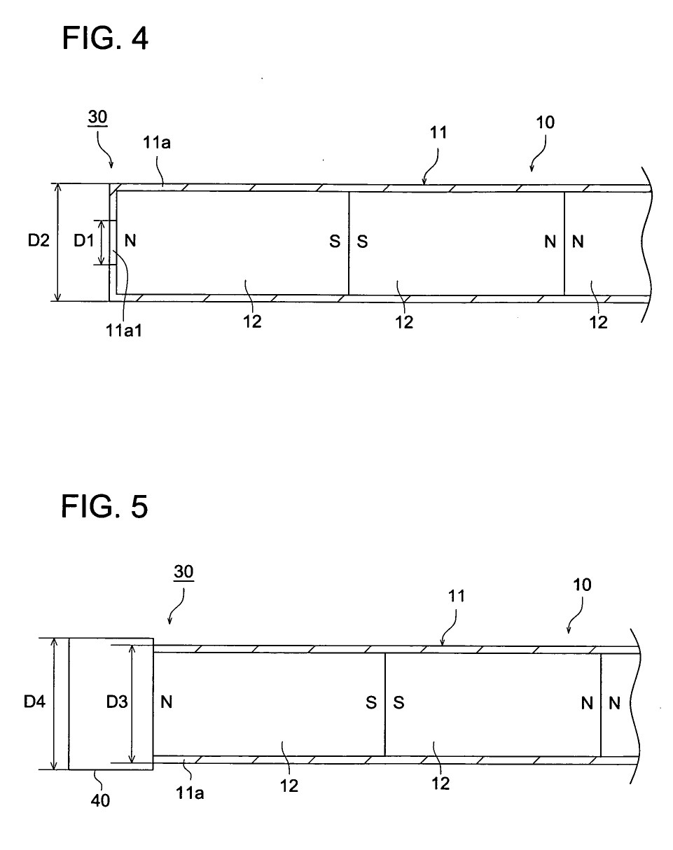

According to the stopper structure 30 shown in FIGS. 1-3 as an embodiment of the present invention, it is possible to tightly close the first end portion 11a of the pipe shaped member 11 and to easily equip the stopper structure by processing the pipe shaped member 11. However, the scope of the present invention is not limited to the above example, but the exemplified structures shown in FIGS. 4-10 are also applicable in the present invention.

In the example shown in FIG. 4, an opening section 11a1 is formed by bending the first end portion 11a of the pipe shaped member 11 toward the inner side of the pipe, so that a diameter D1 of the opening section 11a1 is set at a value smaller than that of a diameter D2 of the plurality of magnets 12, so as not to tightly close the first end portion 11a. According to the example shown in FIG. 4, it is also possible to easily equip the stopper structure 30 by processing the pipe shaped member 11, as well as the example shown in FIGS. 1-3.

In the example shown in FIG. 5, a block member 40 is attached to the first end portion 11a of the pipe shaped member 11. Although the block member 40 is shaped in a solid column, a pipe shaped member is also applicable. According to the example shown in FIG. 5, it is possible to easily equip the stopper structure 30 by attaching the block member 40, serving as a separate member, to the first end portion 11a, without processing the pipe shaped member 11.

A diameter D4 of the block member 40 is set at such a value that is substantially equivalent to that of the diameter D3 of the first end portion 11a of the pipe shaped member 11, so as to joint and fix the block member 40 onto the first end portion 11a. Either a welding process or an adhering process can be employed for joining and fixing the block member 40 onto the first end portion 11a. Since the diameter D4 of the block member 40 is substantially the same as that of the diameter D3 of the first end portion 11a of the pipe shaped member 11, the block member 40 never be an obstacle to the movement of the moving member 20, which is movably mounted on the outer circumferential surface of the pipe shaped member 11.

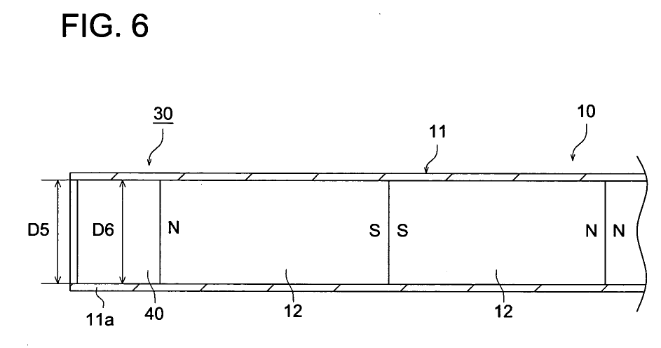

In the example shown in FIG. 6, a block member 40 is attached to the first end portion 11a of the pipe shaped member 11, as well as the example shown in FIG. 5. However, an outer diameter D6 of the block member 40 is smaller than an inner diameter D5 of the first end portion 11a of the pipe shaped member 11, so as to insert and fix the block member 40 into the first end portion 11a. A welding process, an adhering process or a press-fitting process can be employed for fixing the block member 40 onto the first end portion 11a. Since the outer diameter D6 of the block member 40 is smaller than the inner diameter D5 of the first end portion 11a of the pipe shaped member 11, the block member 40 never be an obstacle to the movement of the moving member 20, which is movably mounted on the outer circumferential surface of the pipe shaped member 11.

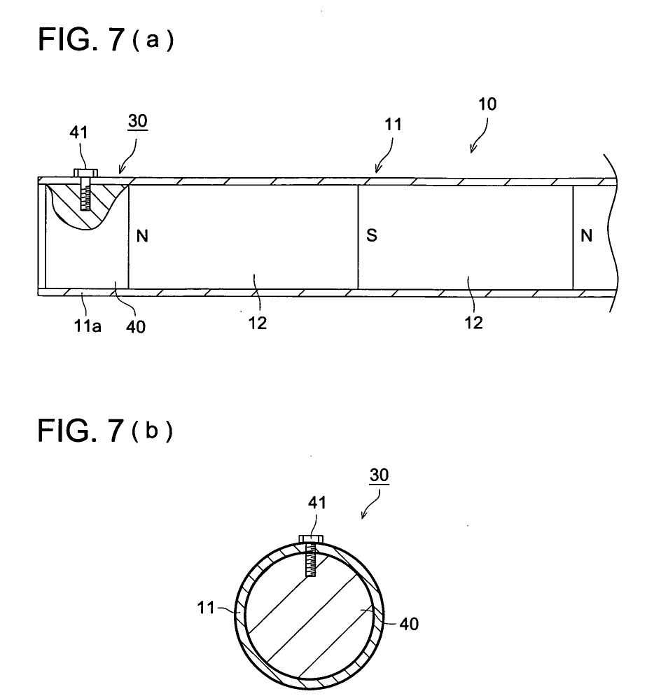

In the example shown in FIG. 7, the outer diameter D6 of the block member 40 is smaller than the inner diameter D5 of the first end portion 11a of the pipe shaped member 11, as well as the example shown in FIG. 6, so that the block member 40 is fitted into the first end portion 11a. Further, the block member 40 is fixed into the first end portion 11a easily and firmly by fastening a fastening member 41, such as a bolt or the like, screwed into the block member 40 from the outer circumferential surface of the first end portion 11a. The length of the a head portion of the fastening member 41, such as a bolt or the like, protruded from the outer circumferential surface of the first end portion 11a of the pipe shaped member 11, is suppressed to a certain small value, so that the head portion of the fastening member 41 does not serve as an obstacle to the movement of the moving member 20, which is movably mounted on the outer circumferential surface of the pipe shaped member 11.

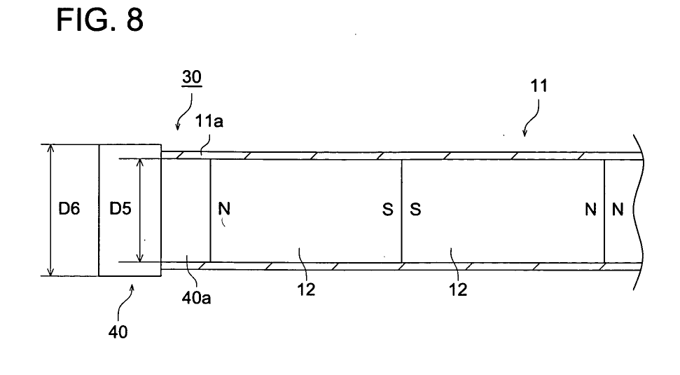

In the example shown in FIG. 8, the block member 40 is jointed and fixed onto the first end portion 11a of the pipe shaped member 11, as well as the example shown in FIG. 5. Further, the block member 40 has a butting portion 40a, which is inserted into the first end portion 11a so as to press-contact final one of the plurality of magnets 12 to hold them. A diameter of the butting portion 40a is set at such a value that is substantially the same as that of the inner diameter D5 of the first end portion 11a of the pipe shaped member 11. However, the scope of the diameter of the butting portion 40a is not limited to the above, but a diameter smaller than the above is also applicable.

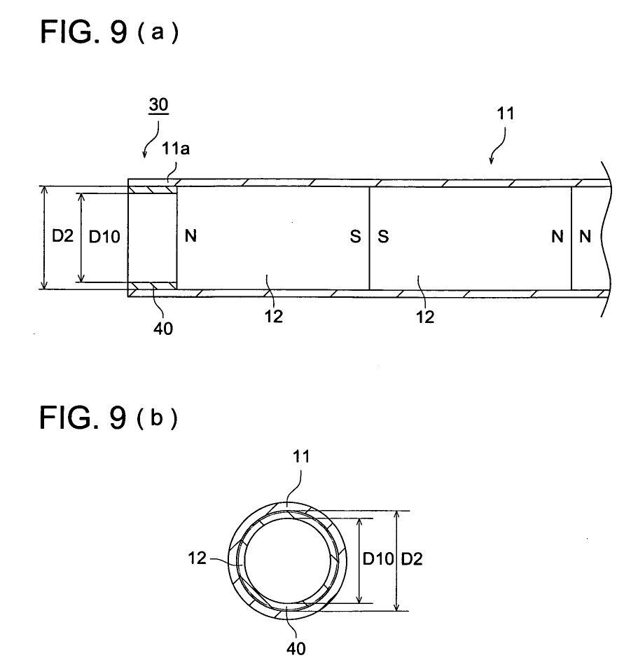

In the example shown in FIG. 9(a) and FIG. 9(b), the outer diameter D6 of the block member 40 is smaller than the inner diameter D5 of the first end portion 11a of the pipe shaped member 11, so that the block member 40 is inserted and fixed into the first end portion 11a, as well as the example shown in FIG. 6. However, the block member 40 is shaped in a hollow cylinder (namely, a pipe). Further, the inner diameter D10 of the block member 40 is smaller than the outer diameter D2 of the plurality of magnets 12, so as to hold the plurality of magnets 12 without dropping them. A welding process, an adhering process or a press-fitting process can be employed for fixing the block member 40 onto the first end portion 11a.

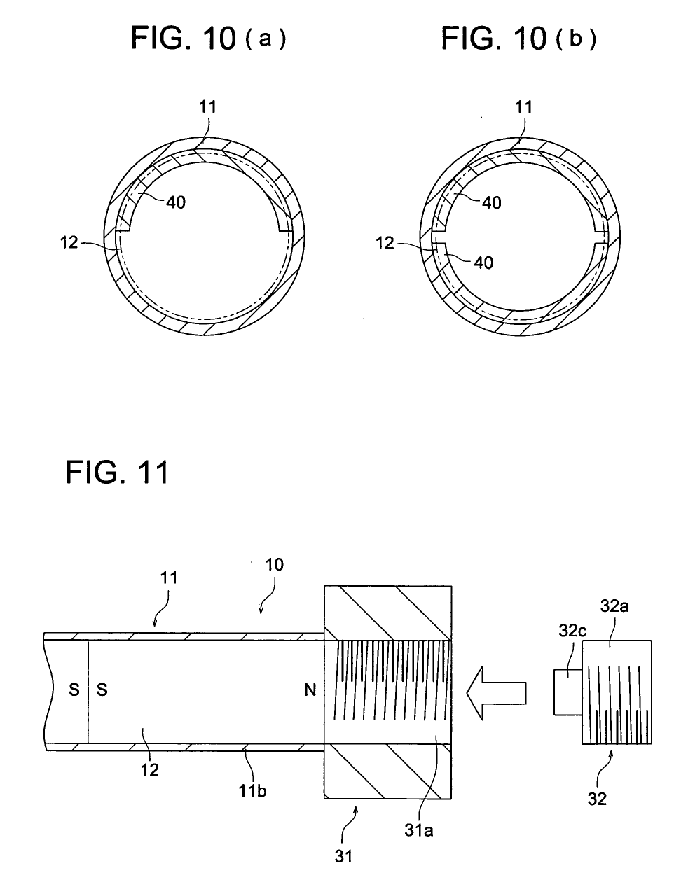

The examples shown in FIG. 10(a) and FIG. 10(b) indicate modified examples of the block member 40 shown in FIG. 9(a) and FIG. 9(b). The block member 40 shown in FIG. 10(a) is shaped in a half-cut pipe, while the block member 40 shown in FIG. 10(b) is shaped in a pare of half-cut pipes. The scope of the shape of the block member 40 is not limited to the above, but three-cut pipes or any other structure for preventing the dropout of the magnets would be applicable for this purpose.

As mentioned in the foregoing, the block member 40 can be shaped in either a solid column or a pipe or the like, and therefore, it becomes possible to easily mount the block member 40, made of a comparatively cheap material, onto the pipe shaped member 11.

Next, referring to FIG. 11, another example of another end portion (hereinafter, referred to as a second end portion) of the linear motor will be detailed in the following. FIG. 11 shows cross sectional view of the main section of the second end portion of the linear motor. As well as the example shown in FIGS. 1-3, the attached block member 31 is attached onto the second end portion 11b of the pipe shaped member 11, so that the holding member 32 can be screwed into the attached block member 31. Further, in this example, the holding member 32 has a protruded section 32c to press the plurality of magnets 12.

As mentioned in the above, since the attached block member 31 is attached onto the second end portion 11b located opposite to the first end portion 11a of the pipe shaped member 11, and the holding member 32 is screwed into the attached block member 31 so as to press the plurality of magnets 12 by the protruded section 32c, it is possible to simply and securely fasten the plurality of magnets 12 without generating any backlash between them.

The shape of the attached block member 31 could be either a rectangular or a cylinder. A welding process, an adhering process, a screw-fastening process, etc. can be employed for fixing the attached block member 31 onto second end portion 11b of the pipe shaped member 11.

Further, it is preferable that the inner diameter of the pipe shaped member 11 is set at a value equal to or smaller than that of the attached block member 31, since the attached block member 31 is previously attached to the pipe shaped member 11, and then, the plurality of magnets 12 can be inserted into the pipe shaped member 11. For this purpose, the holding member 32 has the protruded section 32c, the length of which is set at such a value that the protruded section 32c sufficiently press the plurality of magnets 12 to such an extent that the plurality of magnets 12 tightly contact each other without generating any backlash between them.

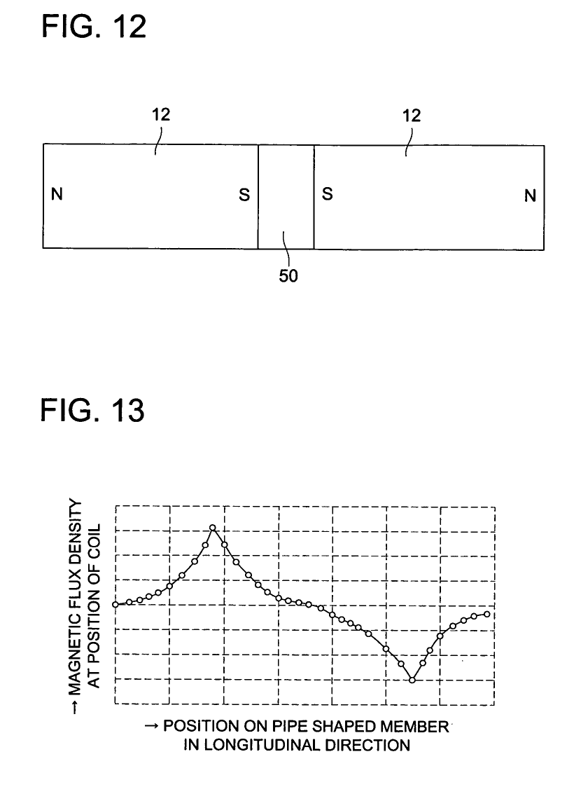

Still further, in this example as shown in FIG. 12, a soft magnetic material 50 is disposed between adjacent magnets of the plurality of magnets 12. For instance, the soft magnetic material 50 could be made of ferrite. It is preferable to dispose the soft magnetic material 50 between the adjacent magnets, since the magnetic repulsing force generated between the adjacent magnets can be weakened and the leakage magnetic flux can be increased, resulting in an increase of the thrust force. It is preferable that the length of the soft magnetic material 50 is set at a value equal to or shorter than 1/10 of the pitch length between the magnetic poles. If the length of the soft magnetic material 50 is set at a value greater than 1/10 of that, the leakage magnetic flux would decrease, resulting in no effect of the soft magnetic material 50. It is applicable that the length of the magnet is not equal to the pitch length for both ends of the soft magnetic material 50. Further, when the length of the pipe shaped member 11 is determined, the length of the magnet located at each of the both ends could be changed to a value different from that of other magnets, in order to adjust the whole length of the pipe shaped member 11.

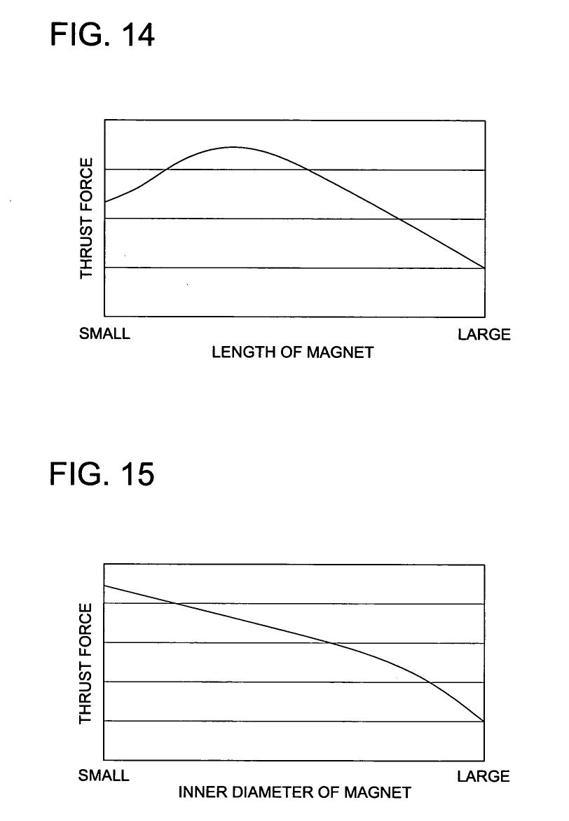

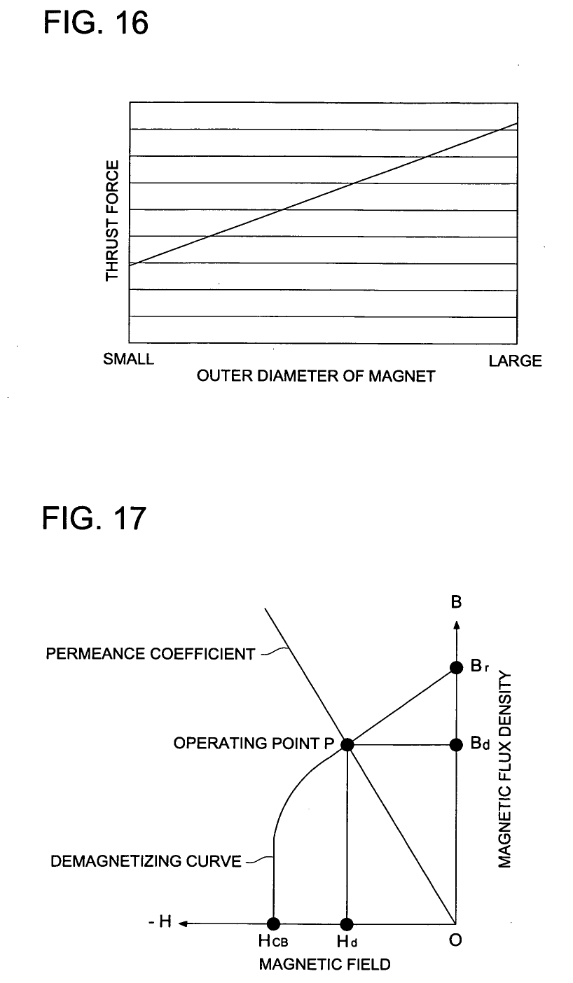

According to the example mentioned in the foregoing, by varying each of the parameters as shown in FIGS. 13-16, it becomes possible to design an optimum linear motor in which a number of magnets to be employed is reduced as small as possible, and a desired thrust force can be generated. FIG. 13 shows calculation results of the magnetic flux densities, FIG. 14 shows a simulation of the thrust force when varying the length of the magnet, FIG. 15 shows a simulation of the thrust force when varying the inner diameter of the magnet, and FIG. 16 shows a simulation of the thrust force when varying the outer diameter of the magnet.

The above method is generally employed for designing the linear motor. In this connection, the magnet has an irreversible demagnetization property. Since the magnets are aligned in such a direction that the magnets repulse relative to each other, the permeance of the magnets decreases.

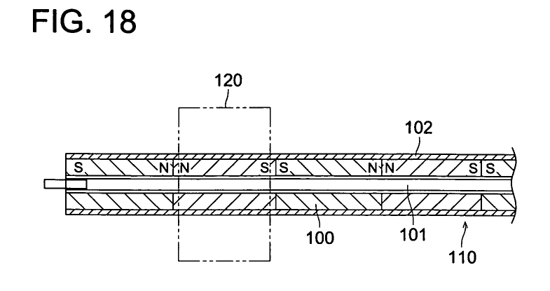

Concretely speaking, the magnet is magnetized by applying the magnetic field onto the magnet, and even after the magnetic field is removed, the magnet continues to emit the magnetic flux to the outside field. The amount of the magnetic flux emitted therefrom is defined as a residual magnetic flux density. In reality, since the magnets are used in such a state that the magnetic field having a polarity opposite to that used for magnetizing them (the demagnetizing field) is applied to the magnets, only a small amount of the magnetic flux, whose magnetic flux density is smaller than the residual magnetic flux density, is emitted to the outside field. The nearer the N pole approach the S pole, namely, the smaller the dimensional ratio (length/diameter) becomes, the greater the demagnetizing field becomes. Considering the demagnetizing field mentioned in the above, when the magnetic field effectively exerted to the magnet is −Hd shown in FIG. 17, the magnet emits the magnetic flux, whose magnetic flux density is Bd corresponding to the H=−Hd plotted on the B-H curve (the demagnetizing curve).

Hereinafter, p=Bd/Hd is defined as a permeance coefficient, and an intersection P of the straight line, drawn from the origin and having a gradient of Bd/Hd, and the B-H curve, is called an operating point P. The term “permeance” means a degree of penetration easiness, namely, a conductivity of the magnetic flux, and would be equivalent to the electric resistivity (electric current/voltage) when the magnetic flux is substituted by the electric current. The operating point P varies depending on the shape of the magnet and circumferential conditions. For instance, even if the operating point of the magnet was located at point P shown in FIG. 17 just after the magnetizing operation was completed, the effective magnetic field exerted to the magnet would shift toward the origin when the magnet attracts a peace of ferrite plate on it.

Further, for instance, when employing a magnet having a low coercive force, the demagnetization of the magnet would occur even in the room temperature. Therefore, the coercive force of the magnet should be high to some extent. The temperature, at which the irreversible demagnetization of the magnet occurs, can be calculated from the B-H curve of the magnet by calculating the permeance by employing the magnetic field calculating software.

The rare metal magnetic material is preferably employed for the magnet. Among the rare metal magnetic materials, a neodymium material can be preferably employed for this purpose. However, the scope of the magnetic material is not limited to the above, as far as the magnet to be employed has a sufficient coercive force, the irreversible demagnetization of the magnet does not occur within a range of the operating temperature and the magnet has a sufficient magnetic energy to such a extent that the necessary thrust force can be acquired. When the neodymium material is employed for the magnet, a problem of the rust would occur. Concretely speaking, when the magnets are inserted into the pipe shaped member 11, and a cylindrical member, to be fixed at the first end portion 11a of the pipe shaped member 11, is employed as the stopper, the rust would be scattered over the outside of the cylindrical member, resulting in a possibility of influencing the performance of the apparatus concerned. Further, if the magnet has rusted during a term before the assembling step of the linear motor after the manufacturing step of the magnet, such the rusted portion would result in a breakage of the magnet concerned. To overcome such the problem, it is desirable that the magnet is plated with a metal. For instance, a nickel plating, an aluminum plating, etc. are generally employed for this purpose. However, the kind of plating material is not specifically limited.

### INDUSTRIAL USABILITY

The linear motor is provided with a pipe shaped member, a stator including the pipe shaped member and a plurality of magnets, both of which are accommodated in the stator in such a manner that the plurality of magnets are aligned in a line in the pipe shaped member and same magnetic poles of magnets, being adjacent to each other and included in the plurality of magnets, oppose to each other, and a moving part movably disposed on a circumferential surface of the pipe shaped member in an opposing state. Further, the pipe shaped member is provided with a stopper structure disposed at an end portion of the pipe shaped member so as to prevent the plurality of magnets from dropping out of the pipe shaped member. According to this stopper structure, it becomes possible to assemble and hold the plurality of magnets by inserting the plurality of magnets into the pipe shaped member from the other end of it, resulting in a reduction of a number of parts required and a cost reduction of the assembly. Further, it also becomes possible to simply and securely mount the plurality of magnets into the pipe shaped member without occurring dropouts of the plurality of magnets from the pipe shaped member, and without generating any backlash between them.

1-16. (canceled)

17. A linear motor, comprising:
a stator that includes a pipe shaped member and a plurality of magnets, wherein the plurality of magnets are accommodated in the pipe shaped member in such a manner that the plurality of magnets are aligned in a line in such a direction that same magnetic poles of two adjacent magnets oppose to each other;
a moving section that is movably mounted on a circumferential surface of the pipe shaped member so that the moving section can move along the stator; and
a stopper structure that is disposed at a first end portion of the pipe shaped member so as to prevent the plurality of magnets from dropping out of the pipe shaped member.

18. The linear motor of claim 17,
wherein the stopper structure closely seals the first end portion of the pipe shaped member.

19. The linear motor of claim 17,
wherein the stopper structure is so constituted that an inner diameter of the first end portion is smaller than an outer diameter of the plurality of magnets.

20. The linear motor of claim 17,
wherein the stopper structure is a block member attached to the first end portion of the pipe shaped member.

21. The linear motor of claim 20,
wherein an outer diameter of the block member is substantially equal to an inner diameter of the end portion of the pipe shaped member, and the block member is jointed onto the first end portion of the pipe shaped member.

22. The linear motor of claim 20,
wherein an outer diameter of the block member is smaller than an inner diameter of the first end portion of the pipe shaped member, and the block member is fitted and fixed into the first end portion of the pipe shaped member.

23. The linear motor of claim 21,
wherein the block member has a butting portion fitted and fixed into the first end portion of the pipe shaped member so that the plurality of magnets can be butted against the butting portion.

24. The linear motor of claim 21,
wherein any one of an adhering process, a press-fitting process and a fastening process is employed for joining the block member onto the first end portion of the pipe shaped member.

25. The linear motor of claim 20,
wherein the block member is shaped in either a solid column or a cylindrical pipe.

26. The linear motor of claim 17, further comprising:
a holding member that is disposed at a second end portion located opposite to the first end portion at which the stopper structure is disposed, to hold the plurality of magnets within the pipe shaped member.

27. The linear motor of claim 26, further comprising:
an attached block member that has a female screw section and is disposed at the second end portion located opposite to the first end portion;
wherein the holding member is screwed and fixed into the attached block member.

28. The linear motor of claim 26,
wherein the holding member is provided with a protruded section for press-pushing the plurality of magnets so as to hold the plurality of magnets.

29. The linear motor of claim 17,
wherein each of the plurality of magnets is shaped in a column.

30. The linear motor of claim 17,
wherein the stator further includes a soft magnetic material disposed between any two of the plurality of magnets being adjacent to each other.

31. The linear motor of claim 17,
wherein each of the plurality of magnets is made of a rare metal magnetic material.

32. The linear motor of claim 31,
wherein each of the plurality of magnets is made of a neodymium material in a category of the rare metal magnetic material.

33. A method for manufacturing a linear motor, comprising:
accommodating a plurality of magnets in a pipe shaped member in such a manner that the plurality of magnets are aligned in a line in such a direction that same magnetic poles of two adjacent magnets oppose to each other, wherein a stopper structure is disposed at a first end portion of the pipe shaped member so as to prevent the plurality of magnets from dropping out of the pipe shaped member;
attaching a holding member at a second end portion located opposite to the first end portion at which the stopper structure is disposed, so as to hold the plurality of magnets within the pipe shaped member; and
mounting a moving section on a circumferential surface of the pipe shaped member so that the moving section can move along the stator.
